(19) United States
(12) Patent Application Publication
(10) Pub. No.: US 2011/0271478 A1
(43) Pub. Date: Nov. 10, 2011

(54) Detachable, Safety-Promotion and Environmental-Protection Vehicle Wiper Able to Automatically Spray Cleaning Liquid

(76) Inventor: Tzu Chuan Liu, Taipei (TW)

(21) Appl. No.: 12/774,901

(22) Filed: May 6, 2010

(51) Int. Cl. B60S 1/02

(52) U.S. Cl. 15/250.04

(57) ABSTRACT

A detachable, safety-promotion and environmental-protection vehicle wiper able to automatically spray cleaning liquid comprises a wiper frame, a wiper arm and a rubber strip gripped by the wiper frame. The rubber strip has a gripped member gripped by the wiper frame and a blade for scraping away rainwater. The blade has first via-holes discretely arranged and connected to a pipe. The front edge of the first via-holes has a shelter plate extending downward to cover the blade. The wiper arm has a second via-hole connected to the cleaning water tank by a conduit. The pipe is connected to the second via-hole. When the wiper is actuated, cleaning liquid is sprayed from the first via-holes with the sprayed cleaning liquid neither hindering the driver's vision nor pattering on the surrounding passengers or objects, whereby is promoted driving safety. Further, the shelter plate blocks solar radiation and thus prolongs the wiper's lifetime.

### BACKGROUND OF THE INVENTION

1. Field of the Invention

The present invention relates to a detachable, safety-promotion and environmental-protection vehicle wiper able to automatically spray cleaning liquid, particularly to a vehicle wiper, wherein water or cleaning liquid is sprayed from the first via-holes of the rubber strip, and wherein the shelter plate blocks solar radiation, whereby the sprayed water or cleaning liquid neither hinders the vision of the driver nor spatters on the surrounding passengers or objects, and whereby the service life of the wiper is increased.

2. Description of the Related Art

The nozzles of the conventional windshield washers of a vehicle are usually arranged on the hood and near the lower edge of the windshield. The nozzles spray water or cleaning liquid onto the entire windshield, which are likely to hinder the vision of the driver and affect driving safety. The instantaneous visual obstacle may cause a traffic accident if the vehicle is running on a freeway. When the vehicle runs on a common roadway, the sprayed water or cleaning liquid may spatter on the surrounding passengers or objects, and it may incur some trouble. Besides, the wipers are persistently exposed to solar radiation, which should shorten the service life of the wipers. Based on many years' experience in the related field, the Inventor has been devoted to improving the wiper structure and thus proposes the present invention. The Inventor expects that the present invention can improve the safety of washing the windshield with water/cleaning liquid and wipers.

### SUMMARY OF THE INVENTION

The primary objective of the present invention is to provide a detachable, safety-promotion and environmental-protection vehicle wiper able to automatically spray cleaning liquid, wherein water or cleaning liquid is sprayed from the first via-holes of the rubber strip, and wherein the shelter plate blocks solar radiation, whereby the sprayed water or cleaning liquid neither hinders the vision of the driver nor spatters on the surrounding passengers/objects, and whereby the service life of the wiper is increased.

The detachable, safety-promotion and environmental-protection vehicle wiper able to automatically spray cleaning liquid of the present invention comprises a wiper frame, a wiper arm and a rubber strip gripped by the wiper frame. The rubber strip has a gripped member gripped by the wiper frame. The rubber strip also has a blade used to scrape away rainwater. The upper edge of the blade has a plurality of first via-holes discretely arranged and connected to a pipe. The front edge of the first via-holes has a shelter plate extending downward to appropriately cover the blade. The wiper arm has a second via-hole connected to the cleaning water tank by a conduit. The pipe of the rubber strip is connected to the second via-hole of the wiper arm. When the wiper is actuated, water or cleaning liquid is sprayed from the first via-holes of the rubber strip with the sprayed water or cleaning liquid neither hindering the vision of the driver nor spattering on the surrounding passengers or objects, whereby is promoted driving safety. Further, the shelter plate blocks solar radiation and thus prolongs the service life of the wiper.

The abovementioned shelter plate is fabricated to have an arc-shape section, whereby the shelter plate can cover the blade of the rubber strip without hindering the scraping action of the rubber strip.

### BRIEF DESCRIPTION OF THE DRAWINGS

FIG. 1 is a perspective view schematically showing a wiper according to a first embodiment of the present invention;

FIG. 2 is a perspective view schematically showing a rubber strip of a wiper according to the first embodiment of the present invention;

FIG. 3 is a sectional view schematically showing a wiper according to the first embodiment of the present invention;

FIG. 4 is an assembly drawing schematically showing a wiper according to the first embodiment of the present invention;

FIG. 5 is a diagram schematically showing the operation of a wiper according to the first embodiment of the present invention;

FIG. 6 is a perspective view schematically showing a wiper according to a second embodiment of the present invention;

FIG. 7 is a structural diagram schematically showing a wiper according to the second embodiment of the present invention;

FIG. 8 is a diagram schematically showing the operation of a wiper according to the second embodiment of the present invention; and

FIG. 9 is another diagram schematically showing the operation of a wiper according to the second embodiment of the present invention.

### DETAILED DESCRIPTION OF THE INVENTION

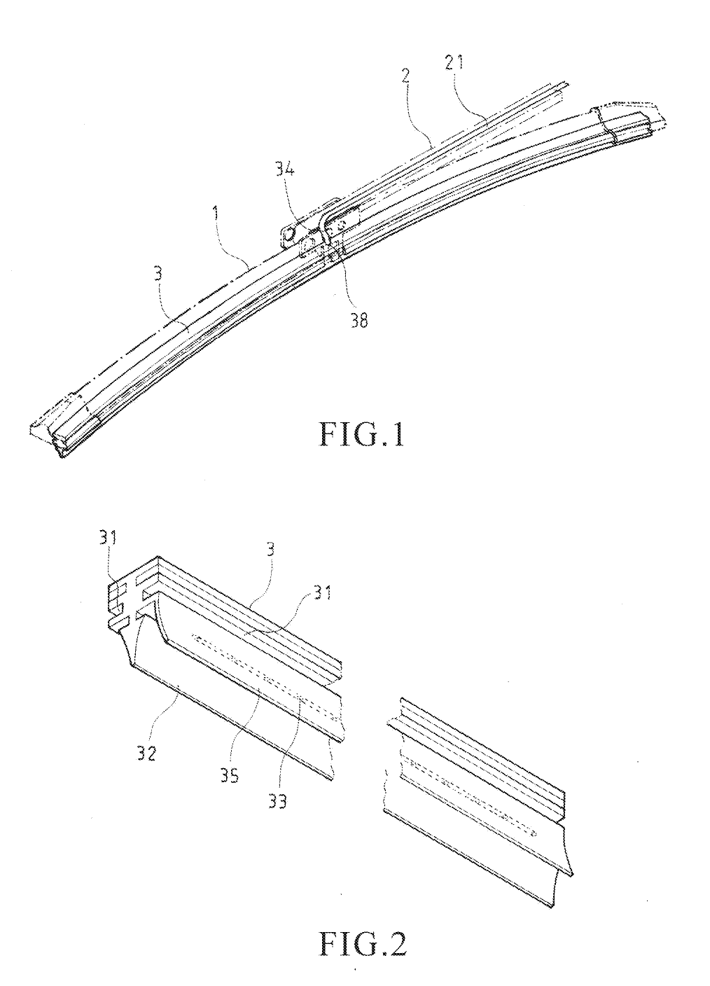

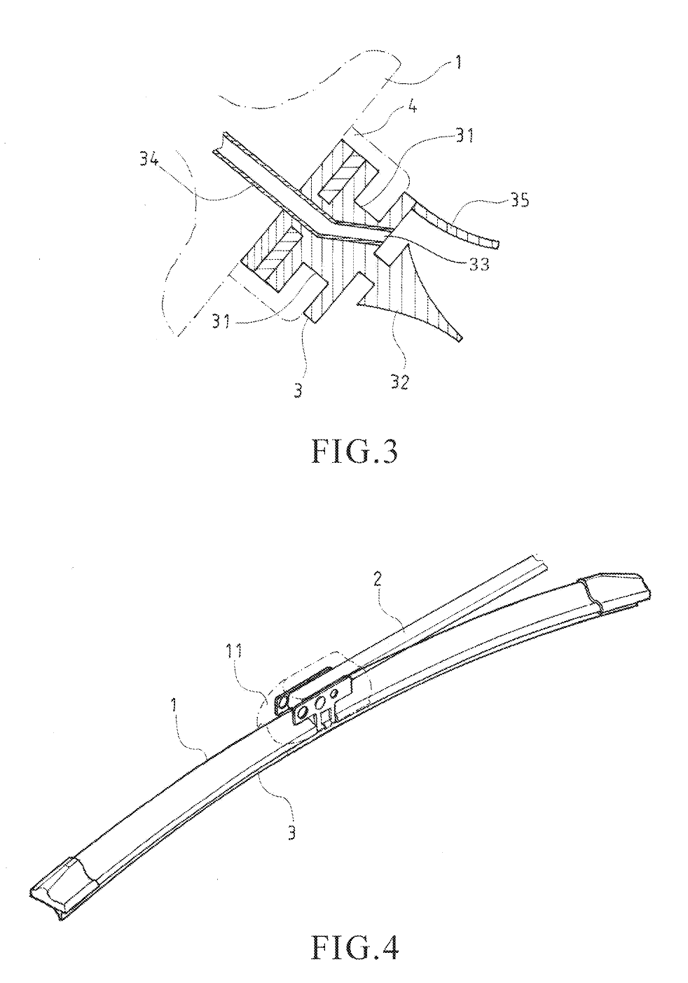

FIG. 1 and FIG. 3 are respectively a perspective view and a sectional view schematically showing a wiper according to a first embodiment of the present invention. FIG. 2 is a perspective view of a rubber strip of a wiper according to the first embodiment of the present invention. Refer to FIGS. 1-3, the wiper of the present invention comprises a wiper frame 1, a wiper arm 2 and a rubber strip 3 gripped by the wiper frame 1. The rubber strip 3 is gripped by a claw member 4 of the wiper frame 1. The rubber strip 3 has a gripped member 31, and the wiper frame 1 grips the gripped member 31. The rubber strip 3 also has a blade 32 for scraping away rainwater. A plurality of first via-holes 33 penetrating the rubber strip 3 is discretely formed on the upper edge of the blade 32 and connected to a pipe 34. The pipe 34 is inserted into a water inlet 38 formed at the center of the wiper frame 1. A shelter plate 35 is arranged on the front edge of the first via-holes 33 and extends downward to appropriately cover the blade 32. In this embodiment, the shelter plate 35 has an arc-shape section.

The wiper arm 2 has a second via-hole 21. The second via-hole 21 is connected to a cleaning water tank by a conduit, and the pipe 34 of the rubber strip 3 is connected to the second via-hole 21 of the wiper arm 2.

When the wiper of the present invention is actuated, water or cleaning liquid is sprayed onto the windshield from the first via-holes 33 of the rubber strip 3. In the conventional windshield washer, water or cleaning liquid is sprayed onto the entire windshield and hinders the vision of the driver. Distinct from the conventional technology, water or cleaning liquid is released from the rubber strip 3 of the present invention, neither hindering the vision of the driver nor spattering on the surrounding passengers/objects. Therefore, the present invention can promote driving safety. Further, the shelter plate 35 blocks solar radiation lest the rubber strip 3 deteriorate. Thus is prolonged the service life of the wiper.

Refer to FIG. 3 for a sectional view of a rubber strip of a wiper according to the first embodiment of the present invention. In the present invention, the upper edge of the blade 32 has a plurality of first via-holes 33 discretely arranged. The first via-holes 33 extend upward to penetrate the rubber strip 3 and connect with the pipe 34. The pipe 34 guides water or cleaning liquid to uniformly flow into the first via-holes 33. The shelter plate 35 is arranged in the front edge of the first via-holes 33 and has an arc-shape section, whereby the shelter plate 35 can appropriately cover the blade 32 without hindering the operation of the rubber strip 3.

Refer to FIG. 4 for an assembly drawing of a wiper according to the first embodiment of the present invention. Similar to the conventional wiper, the wiper arm 2 of the present invention is securely hooked to the wiper frame 1. Besides, a cover 11 hoods the central portion of the wiper frame 1.

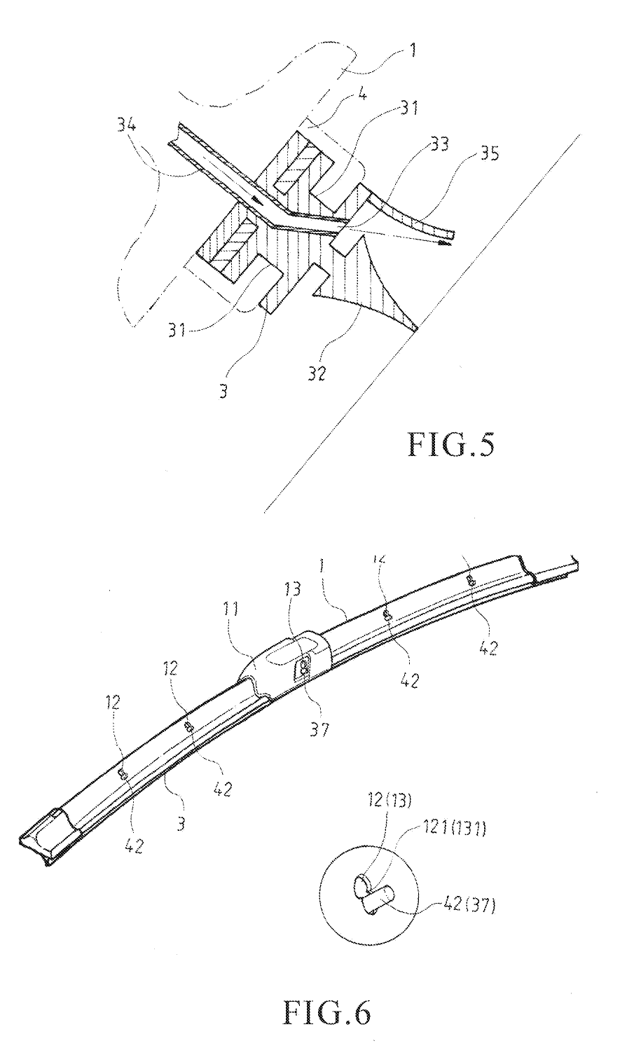

Refer to FIG. 5 a diagram schematically showing the operation of a wiper according to the first embodiment of the present invention. When the wiper of the present invention is actuated, water or clean liquid is guided from the cleaning water tank through the pipe 34 of the rubber strip 3 to the first via-holes 33 and then sprayed onto the windshield. When the vehicle runs at a high speed, water or cleaning liquid, which is sprayed from the first via-holes 33 of the rubber strip 3 to clean the windshield, would not hinder the vision of the driver. Thus is promoted driving safety. When the vehicle is parked or runs on a common roadway, water or cleaning liquid, which is sprayed from the first via-holes 33 of the rubber strip 3 to clean the windshield, would not spatter on the surrounding passengers or objects. Further, the shelter plate 35 can appropriately block the solar radiation projected on the blade 32 lest the rubber strip 3 deteriorate. Thus is prolonged the service life of the wiper.

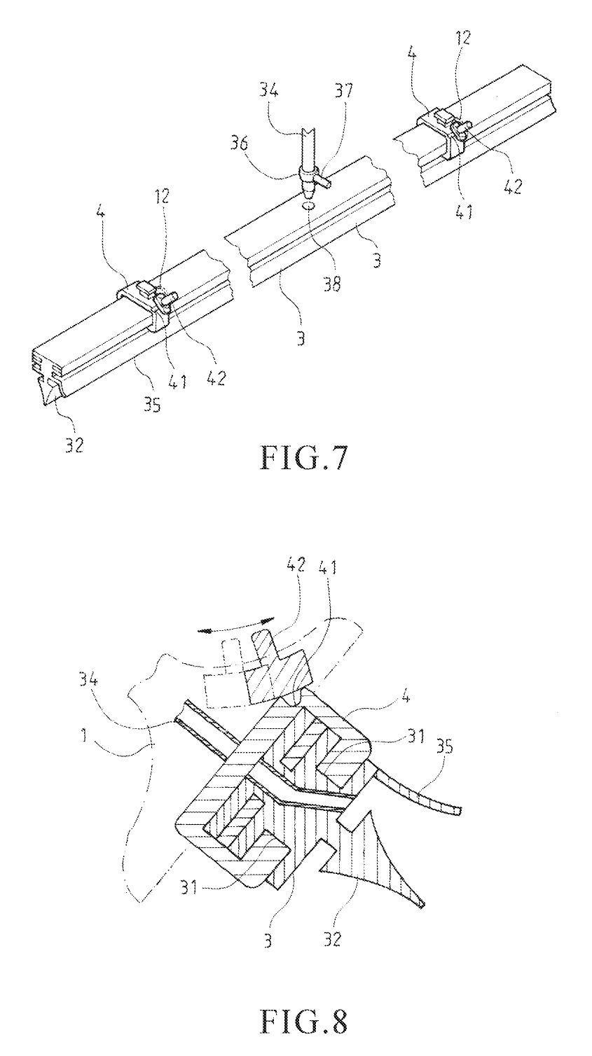

Refer to FIG. 6 and FIG. 7 respectively a perspective view and a structural diagram schematically showing a wiper according to a second embodiment of the present invention. In this embodiment, a plurality of claw members 4 is arranged inside the wiper frame 1. The claw member 4 has an about U shape. The claw member 4 has a groove 41 at the intersection of the horizontal and vertical planes thereof. The groove 41 enables the claw member 4 to expand. The wiper frame 1 has first elongated holes 12, and each first elongated hole 12 has a first stopper portion 121. A clamp rod 42 penetrates the first elongated hole 12 and protrudes from the wiper frame 1. Thereby, the clamp rod 42 can slide up and down along the first elongated rod 12.

A fixing ring 36 sleeves the terminal of the pipe 34, and a control rod 37 is coupled to the fixing ring 36. The cover 11 has a second elongated hole 13, and the second elongated hole 13 has a second stopper portion 131. The control rod 37 penetrates the second elongated hole 13 and protrudes from the cover 11. Thereby, the control rod 37 can slide up and down along the second elongated hole 13.

When the rubber strip 3 needs changing, the clamp rod 42 and the control rod 37 are respectively pulled upward to pass the first and second stopper portions 121 and 131 and positioned at the upper regions of the first and second elongated holes 12 and 13. Thus, the claw member 4 is expanded to release the rubber strip 3, and the pipe 34 is detached from the water inlet 38 of the rubber strip 3. Thereby, the old rubber strip 3 can be drawn out from the claw member 4. After the new rubber strip 3 is placed along the claw member 4, the clamp rod 42 and the control rod 37 are respectively pulled down to pass the stopper portions 121 and 131 and positioned at the lower regions of the first and second elongated holes 12 and 13. Thus, the clamp rod 42 props against the groove 41 of the claw member 4 and forces the claw member 4 to tightly grip the rubber strip 3. At the same time, the pipe 34 is inserted into the water inlet 38 of the rubber strip 3 to supply water into the rubber strip 3. Therefore, the rubber strip 3 can be easily replaced in the present invention.

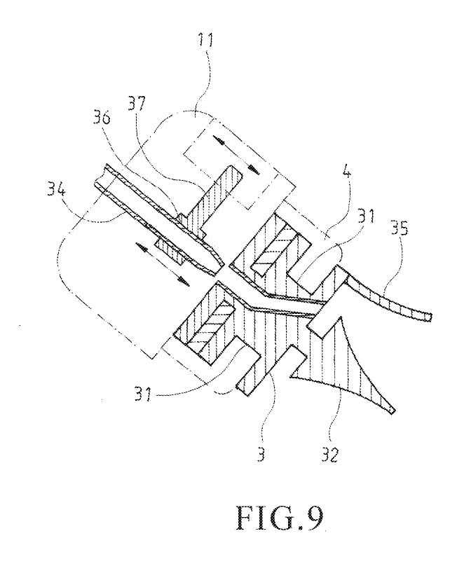

Refer to FIGS. 7-9. FIG. 8 and FIG. 9 are diagrams schematically showing the operation of a wiper according to the second embodiment of the present invention. In this embodiment, the clamp rod 42 normally props against the groove 41 of the claw member 4 to force the claw member 4 to tightly grip the rubber strip 3, and the pipe 34 is inserted into the water inlet 38. When one intends to replace the rubber strip 3, he can expand the claw member 4 to release the rubber strip 3 from the claw member 4 and detach the pipe 34 from the water inlet 38 of the rubber strip 3 via merely pulling up the clamp rod 42 and the control rod 37. Then, the old rubber strip 3 can be drawn out. After having placed the new rubber strip 3 along the claw member 4, he pulls down the clamp rod 42 and the control rod 37 to make the clamp rod 42 prop against the groove 41 of the claw member 4 to force the claw member 4 to tightly grip the rubber strip 3, and make the pipe 34 inserted into the water inlet 38. Thus is completed the replacement of the rubber strip 3. Accordingly, the present invention can realize resource efficiency and environmental protection.

The embodiments described above are only to exemplify the present invention but not to limit the scope of the present invention. Any equivalent modification or variation according to the spirit of the present invention is to be also included within the scope of the present invention.

In summary, the present invention proposes a detachable, safety-promotion and environmental-protection vehicle wiper able to automatically spray cleaning liquid, which uses a rubber strip having first via-holes and a wiper arm connecting with a cleaning water tank to spray cleaning liquid to the windshield with the sprayed cleaning liquid neither hindering the vision of the driver nor spattering on the surrounding passengers/objects. Further, the wiper of the present invention has a shelter plate able to block solar radiation and prolong the service life of the wiper. Therefore, the present invention possesses utility, novelty and non-obviousness and meets the condition for a patent. Thus, the Inventor files the application for a patent. It will be appreciated if the patent is approved fast.

What is claimed is:

1. A detachable, safety-promotion and environmental-protection vehicle wiper able to automatically spray cleaning liquid, comprising a wiper frame, a wiper arm and a rubber strip gripped by said wiper frame, and characterized in
that said rubber strip has a gripped member gripped by said wiper frame and a blade for scraping away rainwater, and
that an upper edge of said blade has a plurality of first via-holes penetrating said rubber strip and connected to a pipe inserted into a central region of said wiper frame, and
that a shelter plate extends downward from a front edge of said first via-holes to appropriately cover said blade, and
that a second via-hole is formed in an inner edge of said wiper arm and interconnected with a cleaning water tank of a vehicle by a conduit, and
that said pipe of said rubber strip interconnects with said second via-hole of said wiper arm, and
that said wiper sprays water or cleaning liquid onto a windshield of said vehicle with sprayed water or cleaning liquid neither hindering vision of the driver nor spattering on surrounding passengers or objects, and
that said shelter plate protects said blade from solar radiation and prolongs a service life of said wiper.

2. The detachable, safety-promotion and environmental-protection vehicle wiper able to automatically spray cleaning liquid according to claim 1, wherein said shelter plate has an arc-shape section, whereby said shelter plate can cover said blade of said rubber strip without hindering scraping actions of said rubber strip.

3. A detachable, safety-promotion and environmental-protection vehicle wiper able to automatically spray cleaning liquid, comprising a wiper frame, a wiper arm and a rubber strip gripped by said wiper frame, and characterized in
that said wiper frame has a plurality of claw members having an about U shape, and
that a groove is formed at an intersection of a horizontal plane and a vertical plane of each said claw member and enables said claw member to expand, and
that said wiper frame has first elongated holes each with a first stopper portion, and
that a clamp rod penetrates said first elongated hole to protrude from said wiper frame and can slide up and down along said first elongated rod, and
that a fixing ring sleeves a terminal of said pipe and is coupled to a control rod, and
that said cover has a second elongated hole with a second stopper portion, and
that said control rod penetrates said second elongated hole to protrude from said cover and can slide up and down along said second elongated hole, and
that when said rubber strip needs changing, said clamp rod and said control rod are pulled upward to pass said first stopper portion and said second stopper portion and positioned at upper regions of said first elongated hole and said second elongated hole, whereby said claw member is expanded to release said rubber strip, and said pipe is detached from a water inlet of said rubber strip, and whereby said rubber strip can be drawn out from said claw member, and
that after a new said rubber strip is placed along said claw member, said clamp rod and said control rod are pulled down to pass said first stopper portion and said second stopper portion and positioned at lower regions of said first elongated hole and said second elongated hole, whereby said clamp rod props against said groove of said claw member and forces said claw member to tightly grip said rubber strip, and whereby said pipe is inserted into said water inlet of said rubber strip to supply water into said rubber strip, and whereby said rubber strip can be easily replaced, wherefore is realized resource efficiency and environmental protection.
